(19) United States
(12) Patent Application Publication
(10) Pub. No.: US 2001/0032260 A1
(43) Pub. Date: Oct. 18, 2001

(54) Server

(76) Inventor: Hiroyuki Kaneko, Kawasaki (JP)

Correspondence Address: STAAS & HALSEY, Suite 500, 700 Eleventh Street, N.W., Washington, DC, 20001, US

(21) Appl. No.: 09/765,623

(22) Filed: Jan. 22, 2001

(30) Foreign Application Priority Data
Apr. 13, 2000 (JP) 2000-111458

(51) Int. Cl. G06F 15/16; G06F 15/173

(52) U.S. Cl. 709/225; 709/203; 709/204

(57) ABSTRACT

A server that is accessed from a plurality of groups excludes the influence of other groups, resulting in high-speed processing. When a predetermined user has logged in, a group specifying section specifies a group to which the user belongs. A using environment specifying section specifies a using environment corresponding to a group specified by the group specifying section. A using environment setting section sets an environment which conforms to a using environment specified by the using environment specifying section. To be concrete, an environment is set so that a DB corresponding to the user who has logged in is accessed. A processing section performs a process corresponding to a request from a user in an environment set by the using environment setting section.

### BACKGROUND OF THE INVENTION

(1) Field of the Invention

This invention relates to a server and, more particularly, to a server for performing a predetermined process in response to requests from a plurality of users.

(2) Description of the Related Art

In recent years various application programs have been used in companies etc. in order to increase efficiency in the transaction of business.

Conventionally, an application program has been recorded in a portable medium, such as a CD-ROM, and installed on a personal computer to use.

Some application programs have been recorded in, for example, a recorder 1a in a server 1 shown in FIG. 10 and have been downloaded onto clients 3a through 5a via a network 2 to use.

Installing an application program recorded in a portable medium, such as a CD-ROM, or downloading an application program stored in a server involves installing or downloading operations. This is troublesome.

Furthermore, these methods have enabled an application program and its data to be used only on a particular client on which the application program was installed. For example, it is assumed that a particular application program is installed on the client 3a of “A Company”. It has been difficult to use this application program and its data from another client (not shown) in A Company.

As shown in FIG. 11, therefore, a method in which both an application program and a data base (DB) in which data is stored are located in a server 10 and this application program is started from the clients 3a through 5a to perform a process has been proposed.

With this method, there is no need to install or download individually, resulting in a lighter burden to a user. In addition, if an authenticating process is performed by inputting a company name and password at the time of logging in, an application program and a data base can be used from any client of the company. The above problem therefore will be resolved.

In this method, however, data which belongs to a plurality of companies will be stored in the same data base. Therefore, work (writing to the data base, for example) which is being done by a client of a company may have an influence on work (reading out from the data base, for example) which is being done by a client of another company and may reduce its processing speed. Moreover, data which belongs to a plurality of companies will intermingle in the same data base, so a managing process, such as editing only data regarding a particular company, will become troublesome. Furthermore, this storing system may enable to refer to data of other companies, which diminishes security.

As shown in FIG. 12, therefore, the method of locating servers 11 through 13 according to companies has been proposed. However, this method needs to increase the number of servers each time the number of companies to which services are provided increases. This is troublesome and results in high equipment costs.

### SUMMARY OF THE INVENTION

In order to address such problems, the present invention was made. In other words, an object of the present invention is to provide a server with great security and convenience.

In order to resolve the above problems, a server for performing a predetermined process in response to requests from a plurality of users is provided. This server comprises group specifying means for specifying, in the case of a predetermined user having logged in, a group to which the user belongs, using environment specifying means for specifying a using environment corresponding to a group specified by the group specifying means, and using environment setting means for setting an environment which conforms to a using environment specified by the using environment specifying means.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a view for describing the operating principle of the present invention.

FIG. 2 is a view showing the configuration of an embodiment of the present invention.

FIG. 3 is an example of a screen displayed when a client accesses a server.

FIG. 4 is a view showing an example of a group specifying table.

FIG. 5 is a view showing an example of an environment information specifying table.

FIG. 6 is a view showing an example of an application program selection screen.

FIG. 7 is an example of a screen displayed on the display device of a client when an application program has been started.

FIG. 8 is a view for giving an overview of how a server operates when two users belonging to different groups have logged in.

FIG. 9 is a view showing an example of a process performed by a server when it has received a request.

FIG. 10 is a view showing a conventional method for executing an application program.

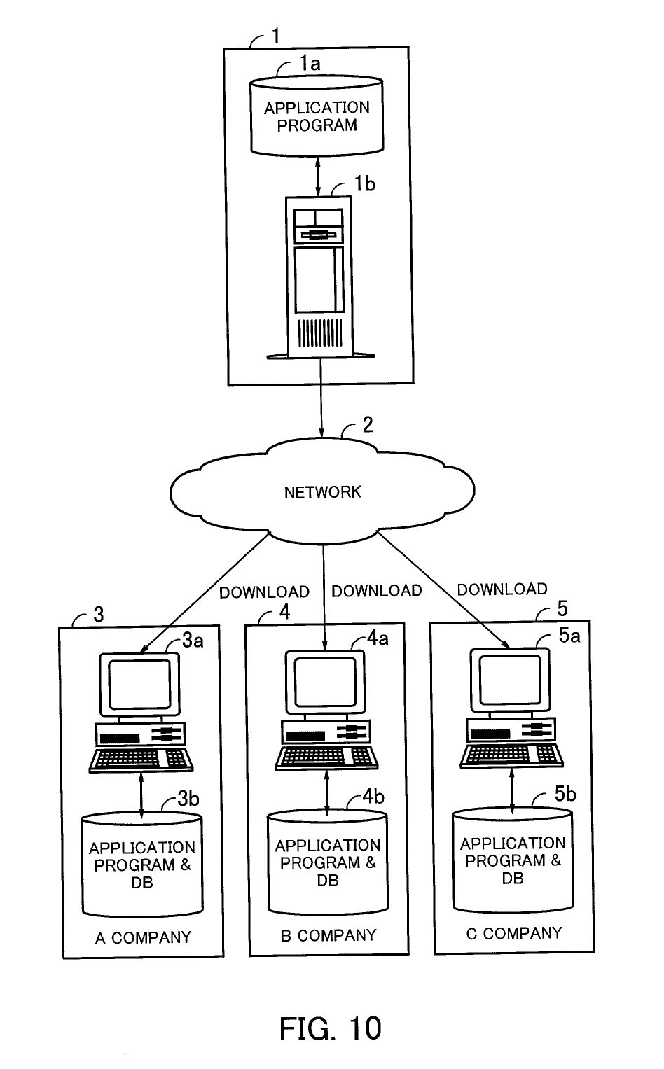

FIG. 11 is a view showing another conventional method for executing an application program.

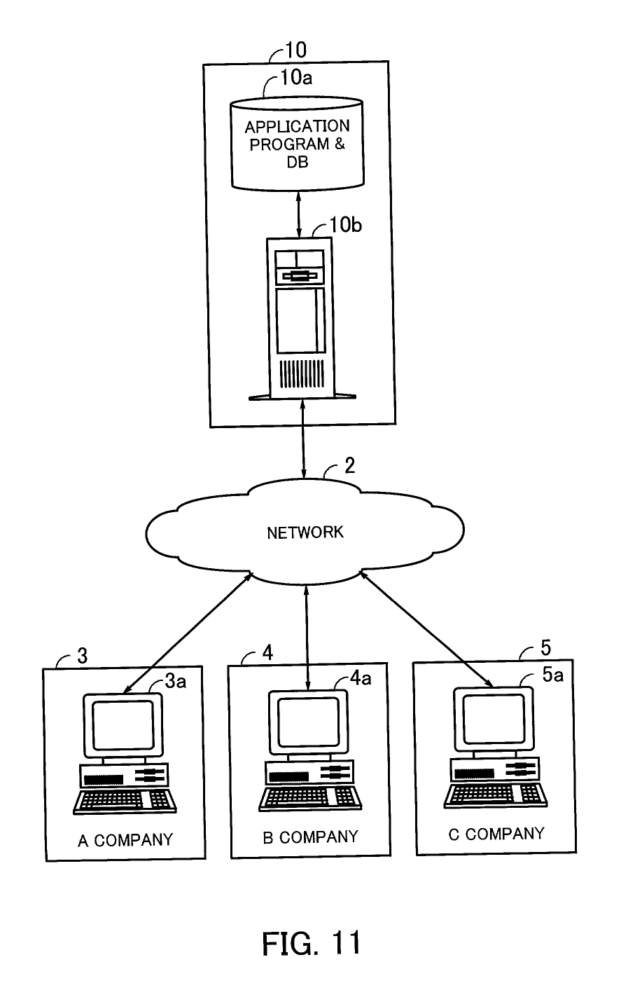

FIG. 12 is a view showing still another conventional method for executing an application program.

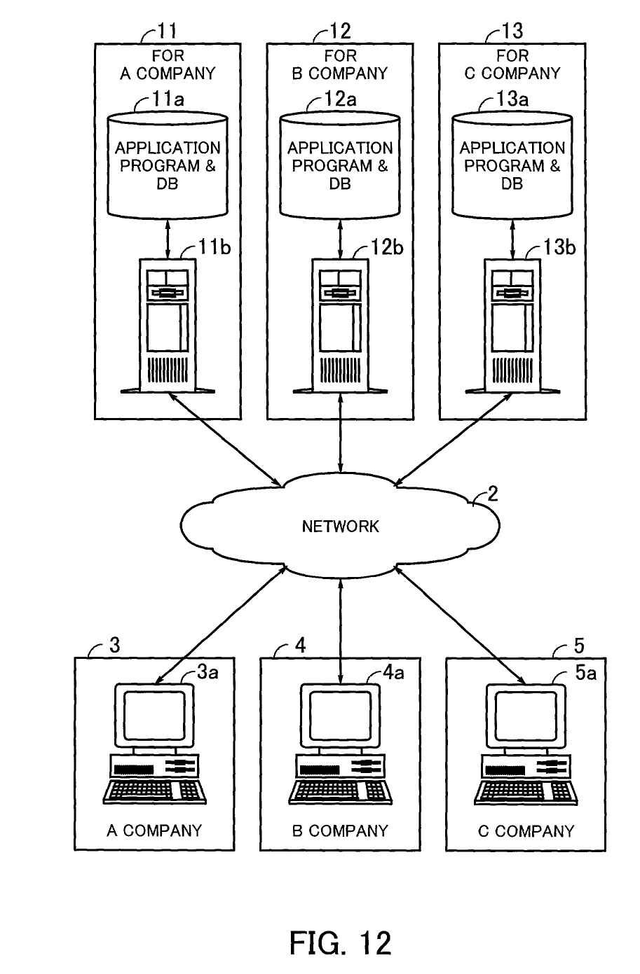

### DESCRIPTION OF THE PREFERRED EMBODIMENTS

An embodiment of the present invention will now be described with reference to the drawings.

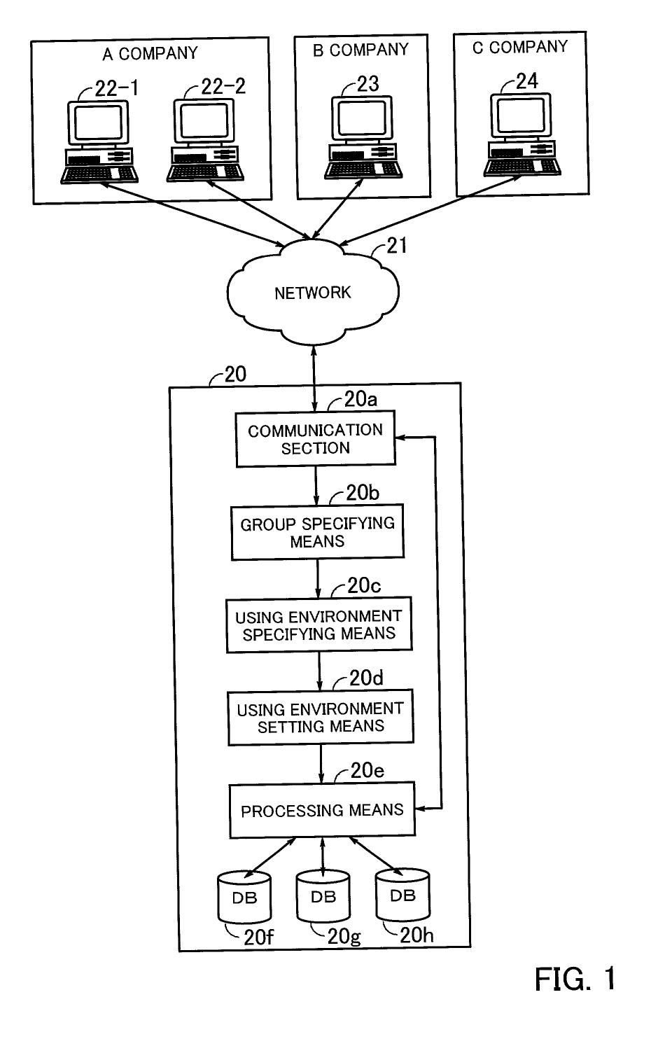

FIG. 1 is a view for describing the operating principle of a server according to the present invention.

In FIG. 1, a server 20 is connected via a network 21 to clients 22 through 24 each located in companies. The server 20 starts application programs and performs various processes, in response to requests from the clients 22 through 24.

The server 20 comprises a communication section 20a, group specifying means 20b, using environment specifying means 20c, using environment setting means 20d, processing means 20e, and data bases (DBs) 20f through 20h.

The communication section 20a performs protocol or data format conversion when it sends data to or receives data from the clients 22 through 24 via the network 21.

When a predetermined user has logged in, the group specifying means 20b specifies a group to which the user belongs. In FIG. 1, each of A Company, B Company, and C Company corresponds to a group.

The using environment specifying means 20c specifies a using environment corresponding to a group specified by the group specifying means 20b.

The using environment setting means 20d sets an environment which conforms to a using environment specified by the using environment specifying means 20c.

The processing means 20e performs a process corresponding to a request from a user.

The DBs 20f through 20h correspond to A Company, B Company, and C Company respectively and store various kinds of data of them.

The network 21 consists of, for example, Internet and transfers data between the clients 22 through 24 and the server 20.

The clients 22 through 24 are clients of the server 20 and perform various processes by the use of application programs stored on the server 20. The clients 22-1 and 22-2 belong to A Company; the clients 23 and 24 belong to B Company and C Company respectively.

Now, operation in the above embodiment will be described.

It is assumed that user X of A Company operates the client 22-1 and tries to access the server 20. The communication section 20a in the server 20 causes user X to input his/her password and user ID in order to judge whether he/she is a regular user.

If he/she proves to be a regular user, then the group specifying means 20b specifies a group to which user X belongs. In this example, user X belongs to A Company, so the group specifying means 20b specifies a group to which user X belongs as “A Company”.

The using environment setting means 20d obtains environment setting information corresponding to a group specified by the group specifying means 20b and sets an environment on the basis of this information. To be concrete, the using environment setting means 20d obtains environment setting information indicating that the DB 20f is assigned to A Company and that its log-in ID is “01010” and sets a using environment on the basis of this information.

The processing means 20e performs a process corresponding to a request from a user in an environment set by the using environment setting means 20d. For example, if user X has made a request to start accounting processing software, then the processing means 20e starts the appropriate application program and gives the application program started instructions to refer to the DB 20f. As a result, user X can perform a process, such as modification, on the data of his/her company stored in the DB 20f.

If a plurality of users have logged in, the processing means 20e specifies users who made requests, and assigns these requests to the appropriate application programs. Therefore, even if a plurality of users have made requests for a process, they can be processed properly.

As stated above, a server according to the present invention stores environment setting information according to groups, specifies a group to which a user who accessed belongs, obtains environment setting information corresponding to the group specified, and sets an environment. It therefore can provide various services in response to a request from each group.

Furthermore, DBs according to groups are created and a DB which an application program uses is designated by environment setting. This excludes the influence of DBs of other groups, resulting in high-speed processing and greater security.

An embodiment of the present invention will now be described.

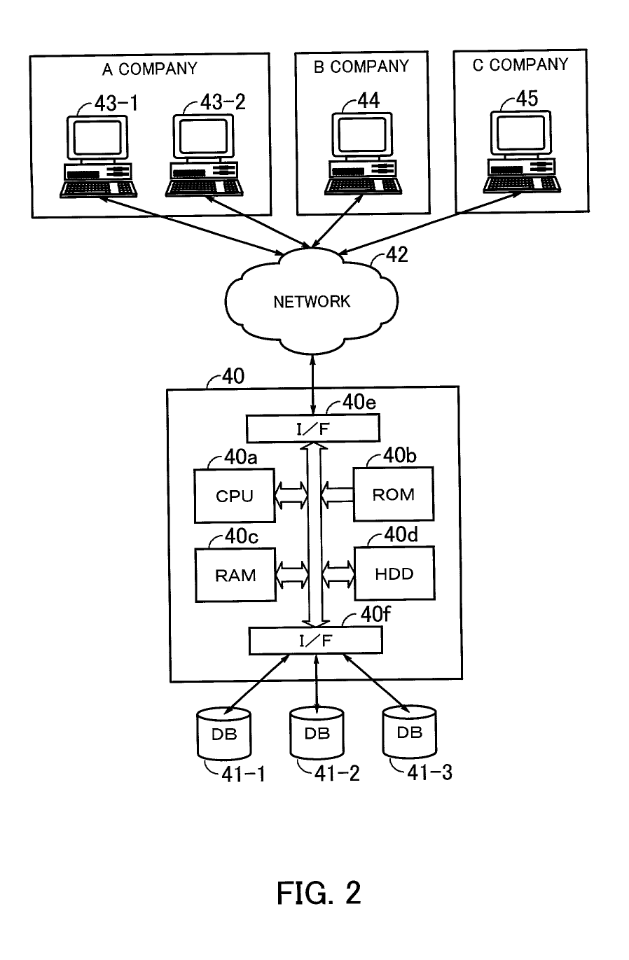

FIG. 2 is a view showing the configuration of an embodiment of the present invention. In FIG. 2, a server 40 starts the appropriate application program and provides services, in response to a request from clients 43 through 45.

The server 40 comprises a central processing unit (CPU) 40a, a read only memory (ROM) 40b, a random access memory (RAM) 40c, a hard disk drive (HDD) 40d, and interfaces (I/F) 40e and 40f. Furthermore, DBs 41-1 through 41-3 are externally connected to the server 40.

The CPU 40a controls each section of the apparatus in compliance with control programs etc. stored in the HDD 40d, starts an application program corresponding to a request from the clients 43 through 45, and performs a process requested.

The ROM 40b stores basic programs executed by the CPU 40a and data.

The RAM 40c temporarily stores programs being executed by the CPU 40a and data being operated by the CPU 40a.

The HDD 40d stores control programs executed by the CPU 40a, application programs started in response to a request from the clients 43 through 45, and the like.

The I/F 40e performs protocol or data conversion when data is sent to or received from the clients 43 through 45 via a network 42.

The I/F 40f consists of, for example, a small computer system interface (SCSI) etc. and sends data to or receives data from the DBs 41-1 through 41-3.

The DBs 41-1 through 41-3 consist of, for example, an HDD etc. and store data for each group.

The network 42 consists of Internet etc. and transmits data between the clients 43 through 45 and the server 40.

The clients 43 through 45 consist of, for example, a personal computer and can make requests for various processes by starting browser software stored in their built-in HDDs and accessing the server 40.

Operation in the above embodiment will now be described.

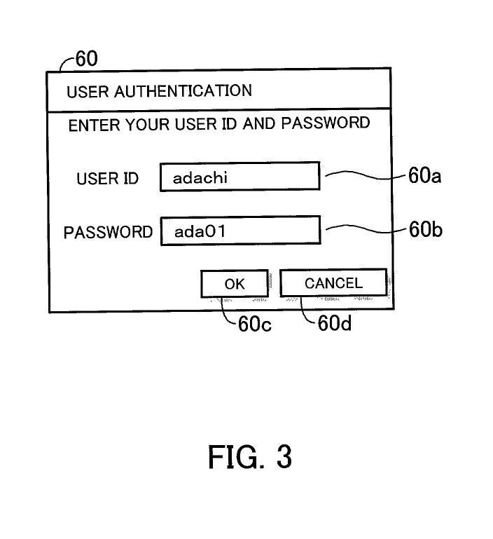

It is assumed that a browser has been started on the client 43-1 of A Company and that an attempt to access the server 40 has been made. The CPU 40a in the server 40 reads out an HTML (hyper text markup language) document for an authentication screen stored in the HDD 40d and sends it to the client 43-1 which has accessed the server 40. As a result, a user authentication screen which looks like the one shown in FIG. 3 will appear on the display device of the client 43-1.

On this screen, it is assumed that a user of the client 43-1 has entered his/her user ID, “adachi,” and password, “adal,” in text boxes 60a and 60b respectively and has operated an OK button 60c. The user ID and password entered are stored in the header of a packet etc. and are sent to the server 40 via the network 42. These user ID and password will be stored in packets sent from the client 43-1 to the server 40 afterward.

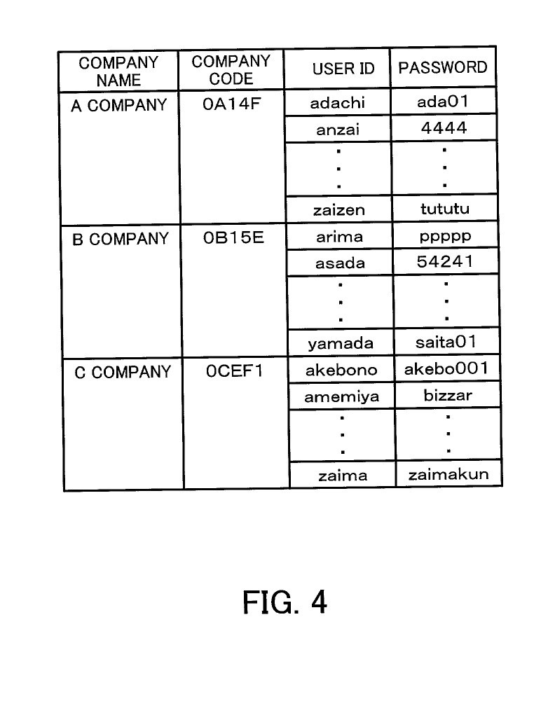

The CPU 40a in the server 40 obtains the user ID and password from a packet received and specifies a group to which the user belongs by referring to a group specifying table (see FIG. 4) stored in the HDD 40d. In this example, user “adachi” is at the top of a list shown in FIG. 4. The name of a group, or company, to which user “adachi” belongs is specified as “A Company” and its company code is specified as “0A14F”.

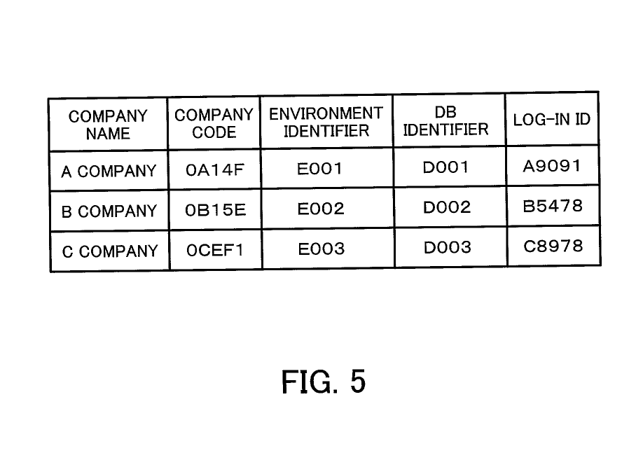

Then the CPU 40a refers to an environment information specifying table (see FIG. 5) stored in the HDD 40d and specifies environment setting information corresponding to the group specified. In this example, a group to which user “adachi” belongs is “A Company,” so the environment identifier “E001,” the DB identifier “D001,” and the log-in ID “A9091” are obtained. An environment identifier is used to specify a piece of environment setting information regarding a user's own group from among a plurality of pieces of environment setting information stored in the HDD 40d. A DB identifier is used to specify one of the DBs 41-1 through 41-3. A log-in ID is necessary when a user logs in a DB. These pieces of information are entered when a group has made a contract with the server 40 side. When the contract has been renewed, these pieces of information are changed in compliance with its contents.

Then the CPU 40a refers to the environment setting information specified, generates an HTML document etc. on the basis of the contents of a contract between the group and the server 40 side, and sends them to the client 43-1. In that case, the CPU 40a stores status information, which associates this user's user ID with the status of the user (an application program being executed now, for example), in the RAM 40c in order to ensure consistency between a request made afterward by this user and a process already performed by referring to this status information.

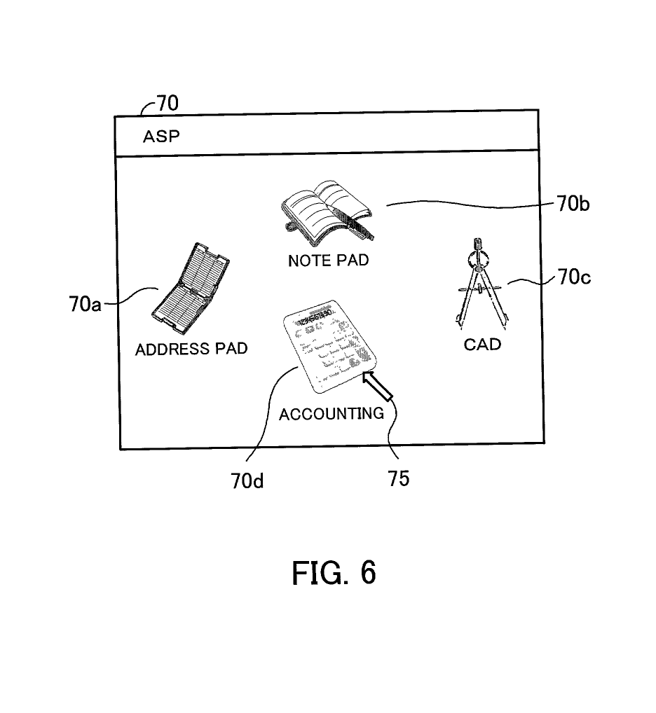

As a result, a screen which looks like the one shown in FIG. 6 will appear on the display device of the client 43-1. In this example, icons indicating application programs for which A Company has contracted are displayed in the display area of a window 70. To be concrete, an address pad 70a, a note pad 70b, computer aided design (CAD) 70c, and accounting 70d are displayed.

On this screen, it is assumed that a user designated the accounting 70d with a pointer 75. The client 43-1 sends the server 40 information indicating that the accounting 70d was designated and a packet which stores this user's ID and password.

First the CPU 40a in the server 40 obtains the user ID and password from the packet received and confirms whether or not this user is a regular one. If he/she is a regular user, the CPU 40a specifies a group to which he/she belongs. Then the CPU 40a refers to the RAM 40c to judge whether status information corresponding to this user exists (that is to say, whether this user has already logged in). If he/she has logged in, the CPU 40a performs a process corresponding to a request. If he/she has not logged in, the above environment setting process will be performed.

In this example, the user has already logged in, so an environment setting process is not performed. A request stored in the packet is obtained and compared with status information. Then a necessary process will be performed. To be concrete, information indicating that the accounting 70d was designated is stored in the packet, so the CPU 40a starts the appropriate application program stored in the HDD 40d. In addition, the CPU 40a sets environment information in the RAM 40c so that the application program started accesses the DB 41-1 corresponding to environment setting information previously obtained. As a result, an application program for an accounting process will be started and access the DB 41-1 designated by the environment information in the RAM 40c.

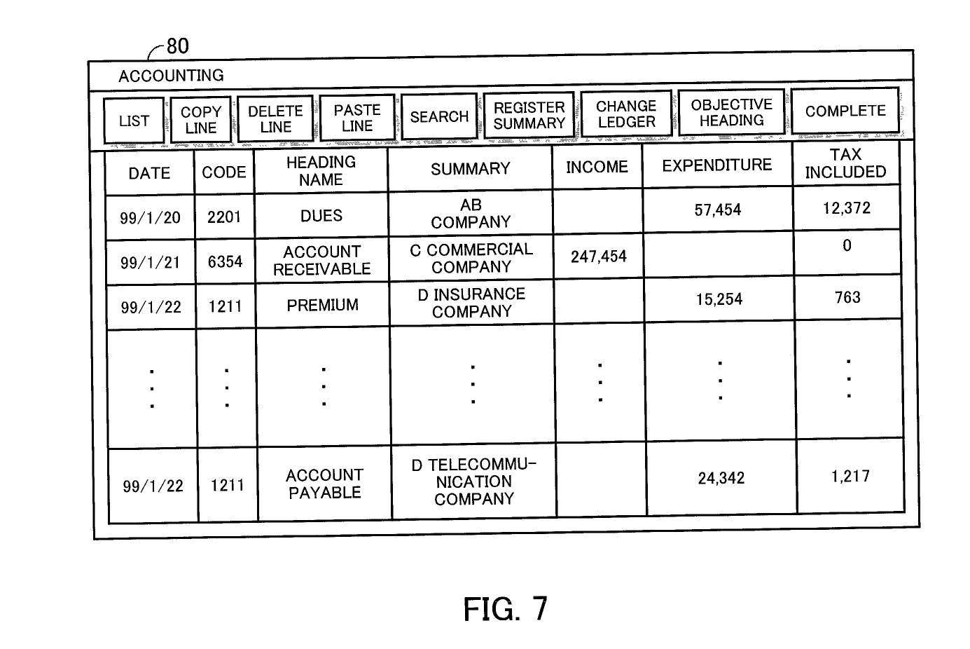

When the application program has been started on the server 40, a screen which looks like the one shown in FIG. 7 will appear on the display device of the client 43-1. In this example, a window 80 titled “Accounting” is displayed. Buttons for executing various commands are displayed at the top of the window 80. In its display area, cells for performing accounting are displayed.

A user can perform an objective process by operating a desired button etc. on this screen. When a button on this screen is operated, the appropriate process will be performed in compliance with the same procedure that has been described above.

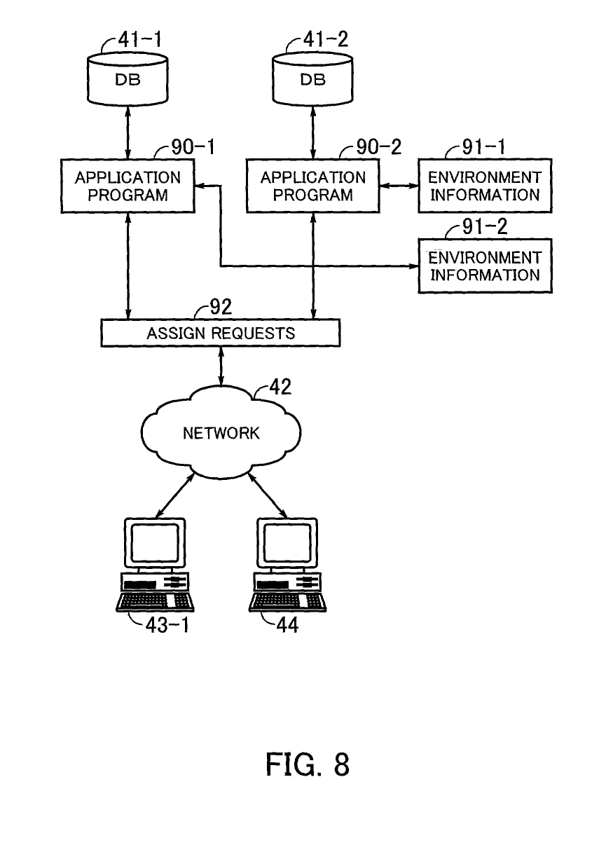

An example in which one user logs in has been described above. However, if a plurality of users log in, the same processing method can be used. FIG. 8 is a view for giving an overview of how the server 40 operates when two users belonging to different groups have logged in. This example shows a case where the clients 43-1 and 44 start the same accounting software.

As shown in FIG. 8, the server 40 refers to a user ID and password included in a packet sent from each of the clients and assigns their requests (92). As a result, a request from the client 43-1 is provided to an application program 90-1 and a request from the client 44 is provided to an application program 90-2. The application programs 90-1 and 90-2 are generated by writing the same application program stored in the HDD 40d into the RAM 40c separately.

The application program 90-1 refers to a DB identifier and log-in ID included in environment information 91-2 and accesses the DB 41-1. On the other hand, the application program 90-2 refers to a DB identifier and log-in ID included in environment information 91-1 and accesses the DB 41-2.

Even if two users belonging to the same group have accessed, the same processing method that is shown in FIG. 8 is applied, except that the same data base is accessed.

As stated above, in the embodiment of the present invention, DBs according to groups are created, a group to which a user who has logged in belongs is specified by his/her user ID and password, and a process is performed on the appropriate data base. This excludes the influence of other groups, resulting in high-speed processing.

Furthermore, an objective data base can be accessed only by entering a user ID and password, which can reduce a burden to a user and exclude access to DBs of other groups.

Now, a flow chart for realizing the above functions will be described.

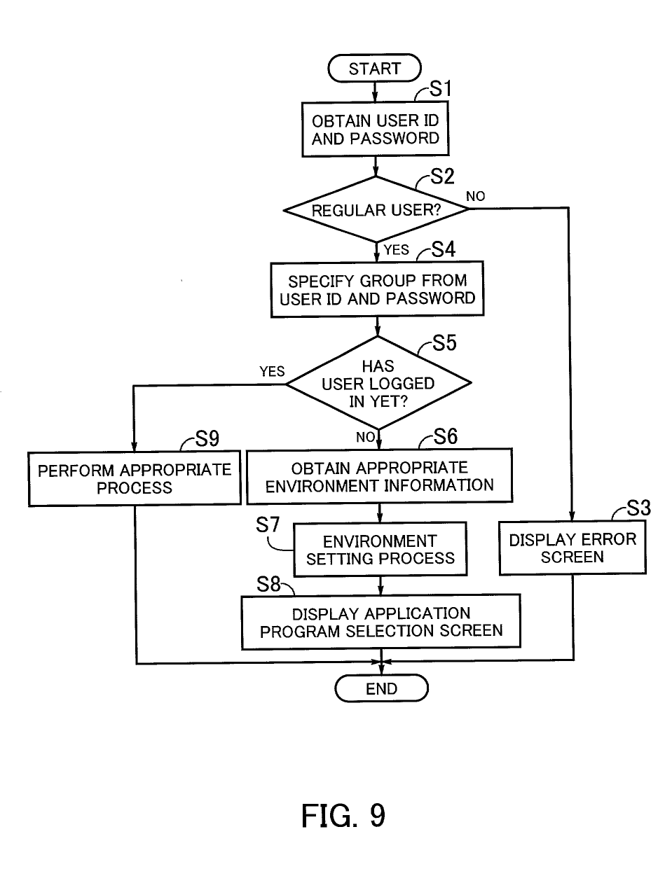

FIG. 9 is a flow chart for describing an example of a process performed on the server 40 when it has received a request from a client. The following procedure will be performed in compliance with this flow chart.

[S1] The CPU 40a obtains a user ID and password stored in a packet received.

[S2] The CPU 40a refers to the group specifying table shown in FIG. 4 and judges whether or not a user who has accessed is a regular one. If he/she is a regular user, the CPU 40a proceeds to step S4. If he/she is not a regular user, the CPU 40a proceeds to step S3.

[S3] The CPU 40a causes the display device of a client which has accessed to display an error screen.

[S4] The CPU 40a refers to the group specifying table shown in FIG. 4 and specifies a group from the user ID and password to which the user who has accessed belongs.

[S5] The CPU 40a judges whether or not this user has already logged in. If he/she has logged in, the CPU 40a proceeds to step S9. If he/she has not logged in, the CPU 40a proceeds to step S6.

The CPU 40a uses status information stored in the RAM 40c in order to judges whether or not this user has already logged in.

[S6] The CPU 40a refers to the environment information specifying table shown in FIG. 5 and obtains the appropriate environment setting information.

[S7] The CPU 40a performs an environment setting process by referring to the environment setting information obtained in step S6.

[S8] The CPU 40a causes the display device of the client which has accessed to display the application program selection screen shown in FIG. 6.

[S9] The CPU 40a performs a process corresponding to a request sent from the user.

This procedure enables to realize the above functions.

DBs in the above embodiment have been physically separate, but they may be physically unitary and logically separate. Moreover, the DB 41-1 through 41-3 and HDD 40d in this embodiment have been physically separate, but all of the DB 41-1 through 41-3 may be integrated into the HDD 40d.

Furthermore, when data is transmitted between a client and a server, it may be encrypted.

In addition, in the above embodiment, a user ID and password have been sent from a client to a server. However, a user ID and password are sent only the first time and only the user ID may be sent afterward.

Finally the above procedure can be achieved with a computer. In that case, the contents of a function which a server must have are described in a program recorded on a record medium which can be read with a computer. The above procedure is achieved with a computer by executing this program on the computer. A record medium which can be read with a computer can be a magnetic recording medium, a semiconductor memory, or the like. In order to place this program on the market, it can be stored on a portable record medium, such as a compact disk read only memory (CD-ROM) or a floppy disk. Alternatively, it can be stored in a memory of a computer connected via a network and be transferred to another computer via a network. When this program is executed on a computer, it is stored on a hard disk etc. in the computer and is loaded into a main memory.

As described above, a server for performing a predetermined process in response to requests from a plurality of users according to the present invention comprises group specifying means for specifying, in the case of a predetermined user having logged in, a group to which the user belongs, using environment specifying means for specifying a using environment corresponding to a group specified by the group specifying means, and using environment setting means for setting an environment which conforms to a using environment specified by the using environment specifying means. This enables to provide very simple operating environments to many users at low cost.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A server for performing a predetermined process in response to requests from a plurality of users, the server comprising:
group specifying means for specifying, in the case of a predetermined user having logged in, a group to which the user belongs;
using environment specifying means for specifying a using environment corresponding to a group specified by the group specifying means; and
using environment setting means for setting an environment which conforms to a using environment specified by the using environment specifying means.

2. The server according to claim 1, wherein the group comprises one or more users.

3. The server according to claim 1, further comprising data bases divided physically or logically according to the groups, wherein the using environment setting means sets a data base corresponding to a group specified by the group specifying means.

4. The server according to claim 1, wherein the group specifying means includes a table which associates user information regarding each user with a group to which each user belongs and specifies the appropriate group by referring to user information which the user entered when the user logged in and the table.

5. The server according to claim 1, further comprising processing means for performing a process corresponding to a request from a user, wherein the processing means performs a process in an environment for each group set by the using environment setting means.

6. A computer-readable record medium recording a computer program for realizing the functions of a server for performing a predetermined process in response to requests from a plurality of groups, the program comprising the functions of:
group specifying means for specifying, in the case of a predetermined user having logged in, a group to which the user belongs;
using environment specifying means for specifying a using environment corresponding to a group specified by the group specifying means; and
using environment setting means for setting an environment which conforms to a using environment specified by the using environment specifying means.
